(19) United States
(12) Patent Application Publication
(10) Pub. No.: US 2015/0050965 A1
(43) Pub. Date: Feb. 19, 2015

(54) LIGHT UP CASE FOR AN ELECTRONIC DEVICE

(71) Applicant: John Perry, Calgary (CA)

(72) Inventor: John Perry, Calgary (CA)

(21) Appl. No.: 13/970,069

(22) Filed: Aug. 19, 2013

(51) Int. Cl. H04M 19/04; H04M 1/02

(52) U.S. Cl. CPC H04M 19/048; H04M 1/026
USPC 455/567

(57) ABSTRACT

A case for an electronic device, the case includes a lighting unit and a light activation unit, where the light activation unit is configured to detect a notifying event in the electronic device and activate the lighting unit.

### FIELD OF THE INVENTION

This invention relates to an electronic device accessory which provides an indication for incoming calls or messages or for other notifications.

### BACKGROUND OF THE DISCLOSURE

Cell phones and other electronic devices used for communication have become indispensable personal gadgets for many individuals. These devices are routinely dropped or are scratched through use and are damaged. A variety of cases are commercially available to protect the phones from scratches, drops and dust.

The currently available cases also cover or minimize some of the built-in warnings that alert the user of incoming calls, especially when the phone is in vibrate mode or when used in noisy surroundings, where the existing ring tones cannot be heard. Thus, a case for an electronic device is needed that provides a visual alert to the user for an incoming call or message.

### SUMMARY OF THE INVENTION

A case for an electronic device, the case includes a lighting unit and a light activation unit, where the light activation unit is configured to detect a notifying event in the electronic device and activate the lighting unit.

### BRIEF DESCRIPTION OF THE DRAWINGS

FIG. 1 illustrates the layout of an embodiment of the light up electronic device case as disclosed herein.

FIG. 2 illustrates the back portion of an embodiment of the light up electronic device case as disclosed herein.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. On the contrary, the invention is intended to cover alternatives, modifications and equivalents that are within the spirit and scope of the invention. Accordingly, the examples should not be construed as limiting the scope of the embodiments herein.

The electronic devices for which the presently disclosed cases are contemplated include those devices that are used for personal communication. Examples of the electronic device include, but are not limited to, a cell phone, a “smart” phone, a personal digital assistant (PDA), a tablet (such as an iPad) or any other device used for communication or alerts.

Throughout the present disclosure and with respect to the disclosed electronic device cases, “front” refers to the part of the case that covers the side of the electronic device having the screen. “Back” refers to the part of the case opposite to the “front.” “Top” refers to the side of the case closest to the top of the screen when the electronic device is used in a normal mode of operation. “Bottom” refers to the side of the case closest to the bottom of the screen when the electronic device is used in a normal mode of operation.

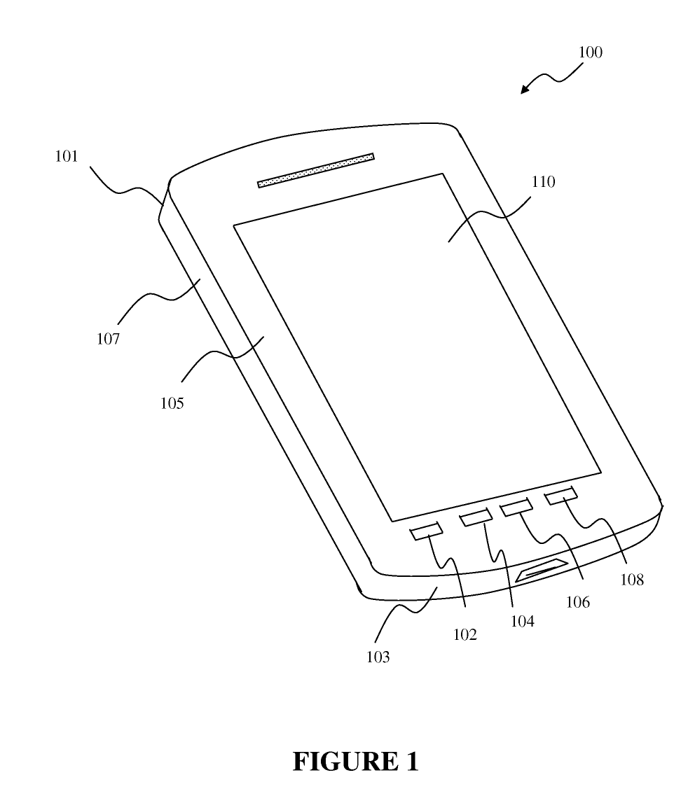

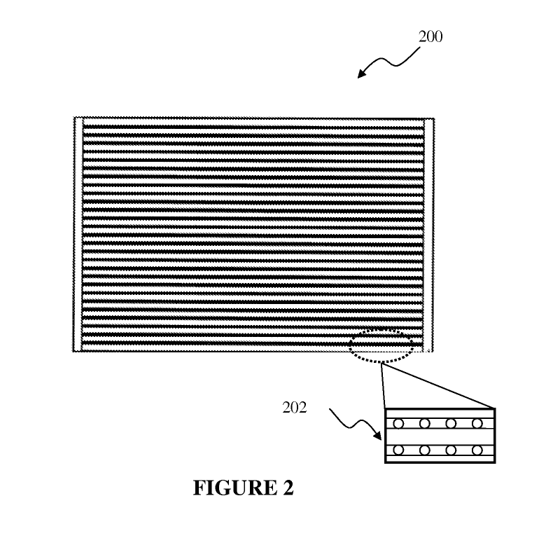

FIG. 1 illustrates the layout of an embodiment of an electronic device case disclosed herein. The case 100 includes a housing having a top side 101, a bottom side 103, a front portion 105, a back portion not shown in FIG. 1 but illustrated in FIG. 2, a first side 107 and a second side not shown in FIG. 1. The case 100 is configured for holding the electronic device. In some embodiments, the electronic device snaps into the case 100, whereas in other embodiments, the user slides the electronic device into the case 100. Other embodiments include those by way of which electronic devices are housed in current commercially available cases. The two portions, i.e., back portion, front portion 105 along with the sides 101, 103, and 107 form a cavity for holding the electronic device. In some embodiments, for example the one shown in FIG. 1, the front portion has an opening 110 in order to slide in the electronic device into the case 100 so that the electronic device display is visible to the user.

FIG. 2 illustrates a lighting unit 200 that illuminates when an alert is to be given to the user. In some embodiments, for example the one illustrated in FIG. 2, the lighting unit 200 is arranged in horizontal lines. In other embodiments, the lines of the lighting unit 200 intersect or are at an angle to each other. In some embodiments, the lighting unit 200 is arranged in straight lines, curved lines, circular lines, angled lines, or the like, or a combination thereof. In some embodiments, the lighting unit 200 comprises a number of light emitting diodes (LEDs). In some embodiments, the LEDs are of a single color, whereas in other embodiments, the LEDs are multi colored or tri colored.

Thus, FIG. 2 shows one embodiment of the lighting unit 200 in which the lighting unit 200 is a series of LEDs arranged in horizontal lines along the back of the case 100. In some embodiments, the lighting unit 200 is arranged along the sides of the case 100 instead of, or in addition to, the back of case 100.

The zoomed in inset of FIG. 2, shows one embodiment of the arrangement 202 of LEDs in the lighting unit 200. The distance between the LEDs and the concentration of the LEDs along a line may be uniform or may vary.

In some embodiments, the lighting unit 200 includes at least one of: at least one LED, at least one fiber optic cable, at least one light tape, or at least one electroluminescent wire. In some embodiments, the lighting unit 200 comprises Light Tape®. Light Tape® is a flexible light bulb that is thin, for example as thin as a business card. Light Tape® is an extremely versatile product, available for indoor or outdoor applications. Light Tape® is available in multiple colors, widths and lengths and provides light in flashing or steady illumination modes. In some embodiments, the voltage and frequency of electricity fed into Light Tape® is adjusted to vary the brightness as well as color hue.

The electroluminescent (EL) wire is a thin copper wire coated in a phosphorescent or electroluminescent material, which glows when an alternating current is applied. The EL wire is not a series of points, but produces a 360 degree unbroken line of visible light. Its thin diameter makes it flexible and ideal for use in a variety of applications, including with the cases disclosed herein. A recent innovation is “quantum EL” or FIPEL, which uses very small amounts of carbon nanotubes around 0.04% wt and iridium based PPV organic compound to increase the efficiency.

In some embodiments, the case 100 comprises a light activation unit configured to detect an event in the electronic device such as, an incoming call, an incoming text message, or a notification regarding emails or other updates for the electronic device, which in turn activates the lighting unit 200. In some embodiments, the lighting unit 200 is activated by using pulse with either modulation or alternating frequencies.

In some embodiments, the front portion of the housing comprises a space 102 to hold a battery. The battery space 102 is in electronic communication with the lighting unit 200. The battery powers the lighting unit 200 and the light activation unit, described below.

In some embodiments, the case 100 comprises a light activation unit configured to detect a notifying event in the electronic device, which in turn activates the lighting unit 200. By “notifying event” it is meant an event with the electronic device, such as an incoming call, an incoming text message, or a notification regarding emails or other updates for the electronic device, for which the user is notified by the activating of the lighting unit 200. In some embodiments, the lighting unit 200 is activated by using pulse with either modulation or alternating frequencies.

In some embodiments, the light activation unit includes a microprocessor 104, which may comprise a printed circuit board. In some embodiments, the microprocessor 104 is programmed to send activation signals to the lighting unit upon detecting one or more of the notifying events. In these embodiments, the lighting unit is illuminated thereby alerting the user.

In some embodiments, the case 100 comprises more than one lighting unit 200. For example, a lighting unit 200 is located in the back of the case 100, while a second lighting unit 200 is located at the top of the case 100, and yet another lighting unit 200 is located at the side of the case 100, and the like. In some of these embodiments, the several lighting units operate independently, i.e., they are activated by a different light activation unit, where each lighting unit 200 is activated by a one notifying event, but not by other notifying events. In some embodiments, there is a single light activation unit, but the light activation unit selectively sends a signal to a different lighting unit 200 depending on the specific notifying event. In another embodiment the lighting unit 200 for a particular notifying event is activated in a particular sequence or order.

In some embodiments, the light activation unit comprises a vibrating trigger switch 106 for detecting vibration of the electronic device to activate the lighting unit. The vibration is detected in response to a particular notifying event.

In some embodiments, the light activation unit further comprises a Bluetooth® communication switch for detecting a notifying event. In some of these embodiments, when a notifying event is received by the electronic device, the electronic device sends a signal through its Bluetooth® communication portal, which signal is received by a Bluetooth® communication receiver on the case 100. The Bluetooth® communication receiver of the case 100 then sends an activation signal to the light activation unit.

In some embodiments, the light activation unit further comprises a near field communication (NFC) switch for detecting a notifying event. In some of these embodiments, when a notifying event is received by the electronic device, the electronic device sends a signal through its NFC portal, which signal is received by a NFC receiver on the case 100. The NFC receiver of the case 100 then sends an activation signal to the light activation unit.

In some embodiments, the case 100 comprises additional components 108, which may be required for the function of the device.

FIG. 1 illustrates one embodiment of the disclosed case 100, in which the battery space 102, the microprocessor 104, the switch 106, and additional components 108 are located in the front of the case 100. The skilled artisan recognizes that these components may be located anywhere on or in case 100 and that the choice of the location of these components is chiefly governed by design considerations.

The case 100 may be constructed using many common materials. In some embodiments, the case 100 is constructed from plastics, while in other embodiments, it is constructed from silicone. The material from which the case 100 is constructed is generally flexible, so that the case 100 can fit around the electronic device. The material is also such that does not interfere with the function of the electronic device, for example signal reception, or with the function of the lighting unit 200, for example by electronic interference. In some embodiments, the case 100 is constructed using an injection molding process. These materials and the methods of manufacture are well-known in the art.

In one embodiment, the case 100 is used for a cell phone. In this embodiment, when the phone receives a call or a message, and the phone is in the vibrate mode, the phone vibrates. The trigger switch 106 senses the vibration and turns the switch to the on position, whereby electricity flows from the battery to the lighting unit 200. The lighting unit 200 then lights up according to a preprogrammed sequence. For example, the lighting unit 200 lights up continuously or intermittently when a phone call is received. Alternatively, the lighting unit 200 lights up in various colors when a phone call is received. Other options for a lighting sequence are within the skill of those of ordinary skill in the art.

What is claimed is:

1. A case for an electronic device, the case comprising;
a. a housing having a top side, a bottom side, a front portion, a back portion, a first side and a second side wherein the housing is configured for holding the electronic device,
b. a lighting unit;
c. a light activation unit; and
d. a battery space, in electronic communication with the lighting unit and the light activation unit.

2. The case of claim 1, wherein the light activation unit further comprises a trigger switch.

3. The case of claim 2, wherein the light activation unit is configured to detect a notifying event in the electronic device; and activate the lighting unit upon detecting the notifying event.

4. The case of claim 3, wherein the notifying event is one of an incoming phone call, a message, or a notification alert.

5. The case of claim 1, wherein the lighting unit comprises at least one of at least one light emitting diode, at least one fiber optic cable, at least one light tape, or at least one electroluminescent wire.

6. The case of claim 1, wherein the lighting unit comprises lines of light-emitting material arranged in a series of straight lines, curved lines, circular lines, or angled lines.

7. The case of claim 1, wherein the lighting unit is on the back portion of the housing.

8. The case of claim 1, wherein the lighting unit is on a side of the housing.

9. The case of claim 2, wherein the trigger switch is configured to detect vibration of the electronic device

10. The case of claim 9, wherein the trigger switch is configured to activate the lighting unit when the trigger switch detects the vibration of the electronic device.

11. The case of claim 2, wherein the trigger switch is configured to detect a signal from a Bluetooth® communication unit.

12. The case of claim 2, wherein the trigger switch is configured to detect a signal from a near field communication unit.

13. The case of claim 1, wherein the lighting unit comprises multi-colored lights.

14. The case of claim 1, wherein the lighting unit is activated by using pulse with modulation.

15. The case of claim 1, wherein the lighting unit is activated by using alternating frequencies.

16. A method of notifying a user of an electronic device of a notifying event, the method comprising:
using a light activation unit in a case for the electronic device, detecting a vibration of the electronic device;
using a switch in the case, completing a circuit between a battery and a lighting unit;
wherein the battery and the lighting unit are provided in the case.

17. The method of claim 16, wherein the notifying event is one of an incoming phone call, a message, or a notification alert.
